(19) United States
(12) Patent Application Publication
(10) Pub. No.: US 2022/0046995 A1
(43) Pub. Date: Feb. 17, 2022

(54) Accessory E-Cigarette Filter Assembly

(71) Applicant: Philter Labs Incorprated, Encinitas, CA (US)

(72) Inventors: Yuval Shenkal, Cardiff-by-the-Sea, CA (US); John Grimm, Santee, CA (US)

(73) Assignee: Philter Labs Incorporated, Encinitas, CA (US)

(21) Appl. No.: 17/514,736

(22) Filed: Oct. 29, 2021

Related U.S. Application Data
(63) Continuation of application No. 16/788,977, filed on Feb. 12, 2020.
Application No. 16/788,977 is a continuation-in-part of application No. 15/070,186, filed on Mar. 15, 2016, now Pat. No. 10,617,148.
Application No. 15/070,186 is a continuation-in-part of application No. 17/171,986, filed on Feb. 9, 2021.
Application No. 17/171,986 is a continuation-in-part of application No. 16/697,676, filed on Nov. 27, 2019, now abandoned.
(60) Provisional application No. 62/804,630, filed on Feb. 12, 2019.
(60) Provisional application No. 62/133,414, filed on Mar. 15, 2015.
(60) Provisional application No. 62/774,276, filed on Dec. 2, 2018.

(51) Int. Cl. A24F 40/485; A24F 7/02; A24F 13/00

(52) U.S. Cl. CPC A24F 40/485; A24F 13/00; A24F 7/02

(57) ABSTRACT

An accessory e-cigarette filter assembly that is essentially a protective sleeve for both a vaporizer/electronic cigarette and an exhale filter is disclosed. The apparatus is further for the purpose of removably pairing an exhale filter to a vaporizer. Also notably, the invention is a removable mouthpiece having dual valve technology that couples to both the vaporizer and the exhale filter via the protective sleeve. The dual valve technology configured for inhale and exhale could also be adapted to other personal air filter applications as desired.

### PRIORITY CLAIM

This patent application is of continuation of U.S. patent application Ser. No. 16/788,977 filed on Feb. 12, 2020 entitled “Accessory E-Cigarette and Filter Assembly,” which claims benefit of the priority date of U.S. Prov. Pat. App. Ser. No. 62/804,630 filed on Feb. 12, 2019 entitled “Accessory e-Cigarette Filter Assembly.” Additionally further, this patent application is a continuation-in-part of U.S. patent application Ser. No. 15/070,186 filed on Mar. 15, 2016, entitled “E-Cigarette with Valve Allowing Exhale Filter,” which in turn, claims benefit of the priority date of U.S. Prov. Pat. App. Ser. No. 62/133,414 filed on Mar. 15, 2015 entitled “E-Cigarette with Valve Allowing Exhale Filter.” Additionally still further, this application is a continuation-in-part, and claims benefit of the priority date of U.S. patent application Ser. No. 17/171,986 filed on Feb. 9, 2021 entitled “Accessory E-Cigarette And Filter Assembly;”, which is a continuation-in-part of U.S. patent application Ser. No. 16/697,676 filed on Nov. 27, 2019 entitled “Accessory E-Cigarette And Filter Sleeve Assembly;” which in turn, claims benefit of the priority date of U.S. Prov. Pat. App. Ser. No. 62/774,276 filed on Dec. 2, 2018 entitled “Accessory E-Cigarette Filter Assembly.” Accordingly, the entire contents of all of these patent submissions are hereby expressly incorporated by reference.

### BACKGROUND OF THE INVENTION

### Field of the Invention

The present invention pertains generally to accessories for smoking devices. More specifically, the present invention relates to a mouthpiece and sleeve for receiving an exhale filter further accommodating and coupling to a vaporizer or e-cigarette.

### Description of the Prior Art

Ever increasing in popularity, “electronic cigarettes/e-cigarettes” and vaporizers typically use an electrical heating element to heat a liquid usually containing a mixture of nicotine and flavorings/extract that produces a mist similar to smoke but without the excessive heat that causes combustion. A useful exemplary apparatus was proposed by Counts et al., U.S. Pat. No. 5,666,978, entitled “Electrical Smoking System for Delivering Flavors and Methods of Making Same,” and was awarded patent protection in 1997. This particular prior art device has a receptacle for receiving tobacco or “tobacco flavored material” and electrical heating elements configured to the device for heating the material in order to emit vapors or aerosol for delivery to a smoker.

Over the intervening years, e-cigarettes have evolved to pen-types, wafer or stick-types, or larger units fitting into a user's hand with a mouthpiece coupled thereto. Further, as e-cigarette use has evolved and gained momentum, either as an alternative to typical cigarettes or smoked flower material, so have accessory items to accompany them. One such accessory currently on the market has been branded the Smoke Buddy®. This device is specifically an external filter for receiving exhaled mist; however, it's a bit bulky, awkward and irregular in shape. Other e-cigarette accessories on the market include holders, containers, cases, and outer protectors such as typical for smart phones. Accordingly, the present invention herein is somewhat of a combination of these accessories further providing a novel and useful mating of a commercial vaporizer or e-cigarette with an original and unique filter. And still further, it is an object of the present invention to provide a removable mouthpiece having valve technology at an interior there to include dual inhale and exhale valve technology.

### BRIEF SUMMARY OF THE INVENTION

The present invention specifically addresses and alleviates the above mentioned deficiencies, more specifically, the present invention, in a first aspect, is an electronic cigarette and/or vaporizer comprising: a mouthpiece for an inhale or an exhale function comprising: a polymer exterior comprising: a cylindrical base; and an inlet plenum at an interior thereto; an opening at a top of the polymer exterior; and a diverter valve for allowing air flow in the inhale or the exhale function, the diverter valve further comprising: a duck bill valve configuration including a pair of flaps meeting at a ridge, the flaps further extending to the cylindrical base.

The mouthpiece of the present invention is further designed removable from a separate main component and the diverter valve is a first of two check valves that allow air flow in opposite directions. Particularly, the is a removable single unitary piece configured to be coupled to a vaporizer in the inhale function or a filter in the exhale function.

In a second aspect, the present invention is a filter assembly for a vaporizer comprising: a dual channel sleeve for receiving a filter on a channel first side and a vaporizer juxtaposed thereto on a channel second side; and a dual mouthpiece coupled to an upper portion of the sleeve additionally connected to the vaporizer and the filter, allowing vapor drawn therethrough in an inhale function and subsequently exhaled to the filter in an exhale function.

The invention in this aspect is additionally characterized as including a jacket configured at least partially around an outside of the dual mouthpiece, the jacket providing impact resistance thereto. Still further, the dual mouthpiece further has an outlet check valve and an inlet check valve, the inlet check valve comprises a duck bill valve configuration including a pair of flaps meeting at a ridge, the flaps further extending to a cylindrical base or the cylindrical base could be substantially rectangular. Among other features, the dual mouthpiece further comprising the inlet check valve further comprising and inlet from the vaporizer comprising a flexible gromet that provides a seal between the vaporizer and the dual mouthpiece. Alternatively, the cylindrical base of the mouthpiece could be polygonal; hence the duck bill valve would also have a base that is polygonal.

While the apparatus and method has or will be described for the sake of grammatical fluidity with functional explanations, it is to be expressly understood that the claims, unless expressly formulated under 35 USC § 112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC § 112 are to be accorded full statutory equivalents under 35 USC § 112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is first perspective illustration of a dual channel filter assembly of the present invention in a first embodiment;

FIG. 1B is a profile illustration of the filter assembly;

FIG. 1C is an additional perspective view from an underneath vantage point;

FIG. 2A is first exploded view of an additional embodiment of the present invention;

FIG. 2B is a more detailed exploded view shown from another angle;

FIG. 2C is a profile view of the illustrated embodiment;

FIG. 2D is a partial cross-sectional view depicting a mouthpiece of the present invention taken along line 2D-2D in FIG. 2C;

FIG. 3A is an additional mouthpiece of the present invention; and

FIG. 3B is a cross-sectional view of the additional mouthpiece taken along line 3B-3B in FIG. 3A.

### DETAILED DESCRIPTION OF PREFERRED EMBODIMENTS

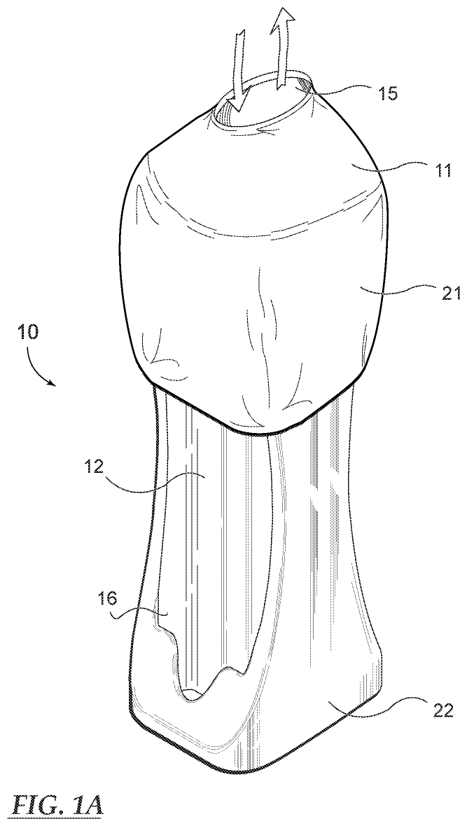

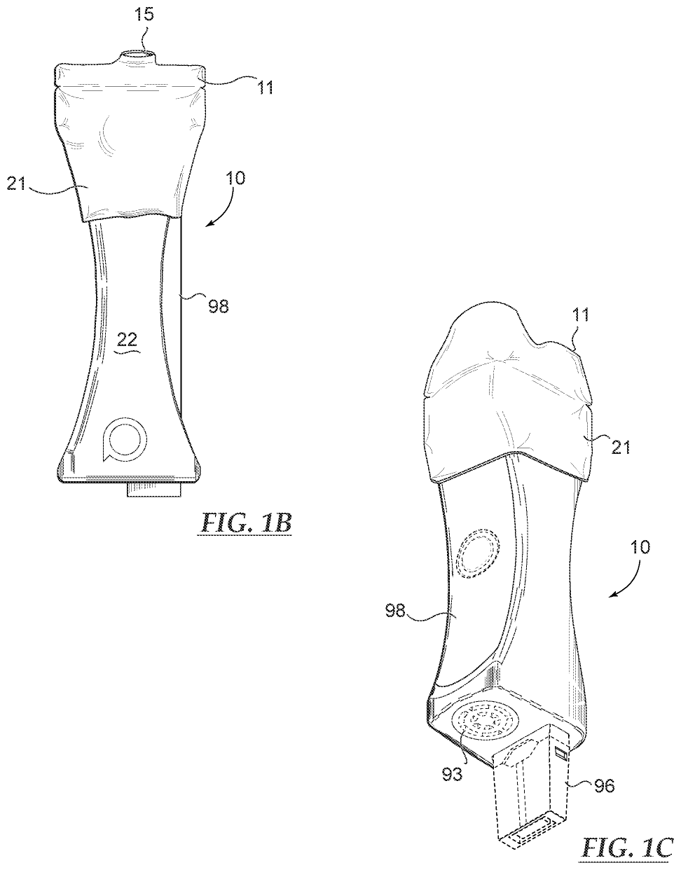

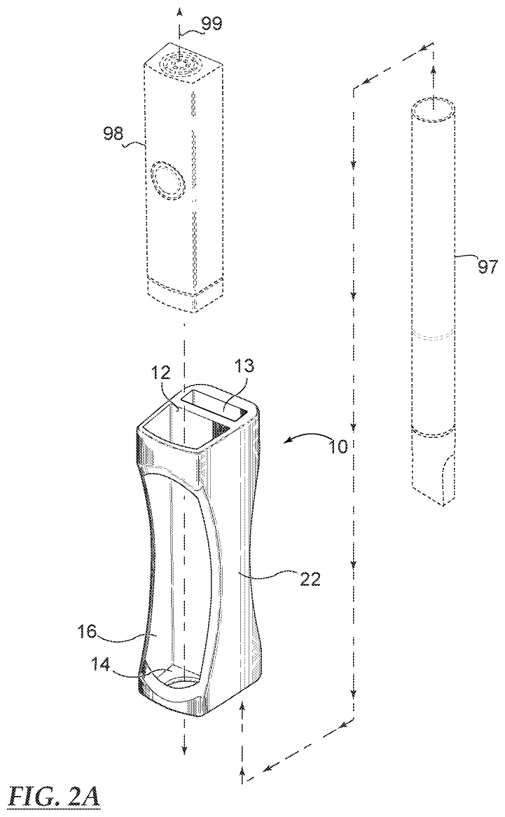

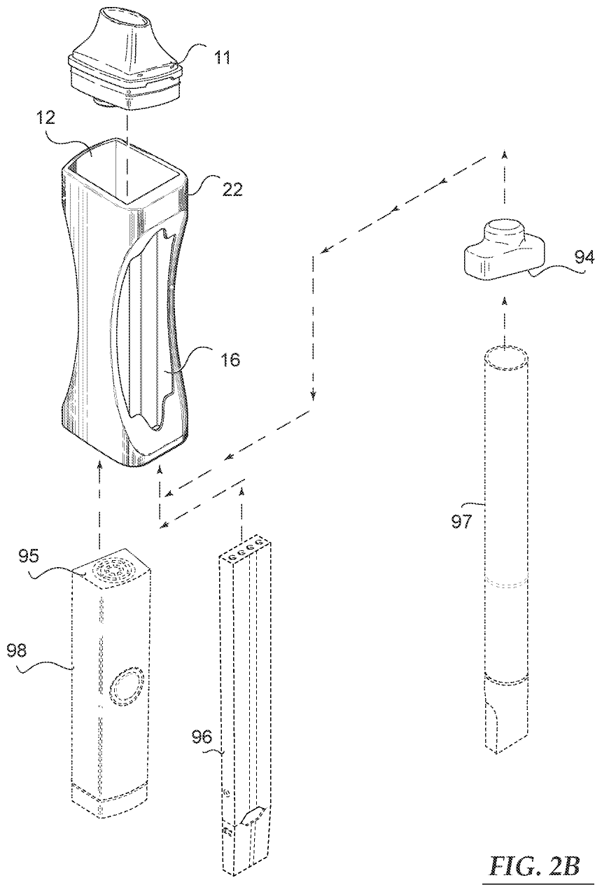

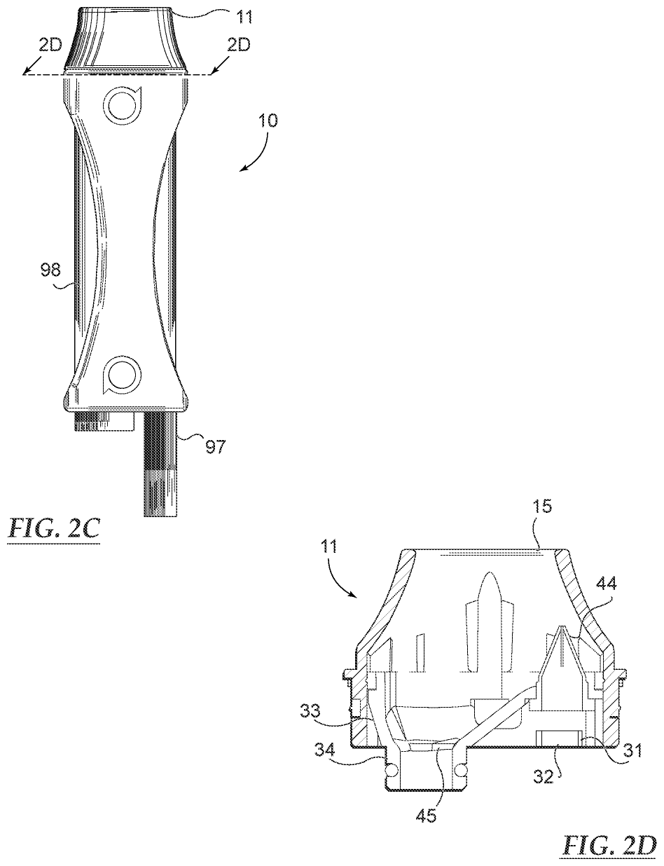

Referring initially to FIG. 1A, the present invention is initially a novel mouthpiece 11 that can be removably coupled to an inhale 96, 97 and/or an exhale 98 device. A polymer (e.g. silicon polymer) sleeve is removably attached to the mouthpiece and holds the vaporizer stick 96 or pen 97 in addition to an exhale filter 98 (FIG. 2B). The mouthpiece has one opening 15 at an apex thereof for both an inhale function and an exhale function. Arrows at the opening 15 illustrate the purpose of the dual channel and the dual directional air flow. A flexible jacket 21 at least partially covers the mouthpiece 11 at a neck area of the device 10, the neck area being defined as the interface between the mouthpiece 11 and the sleeve 21. A relief or opening 16 in the sleeve 22 is provided in order for filter 98 (or vaporizer 96, 97 on the opposite side) to be worked in and/or out by a user when replacing removably attached components 96, 97, 98.

FIG. 1B and FIG. 1C are additional depictions or the device 10 in a profile view and an underneath perspective view, respectively. In some embodiments, the filter 98 may extend beyond the sleeve 22 (FIG. 1B) or the filter 98 exit vent 93 is flush with an end 14 of the sleeve 22 (FIG. 1C). Further with regard to FIG. 1C, the sleeve 22 comprises duel channels for holding the pen 97 and the filter 98. It should be appreciated that the stick 96, pen 97 and filter 98 are sometimes shown with dashed lines or without dashed line because different invention embodiments can alternatively include these device 96, 97, 98 or not. The filter 98 is provided to scrub and subsequently condense vapor importantly providing near zero emissions needed for closed environments where exhaled vapor may be prohibited or undesired.

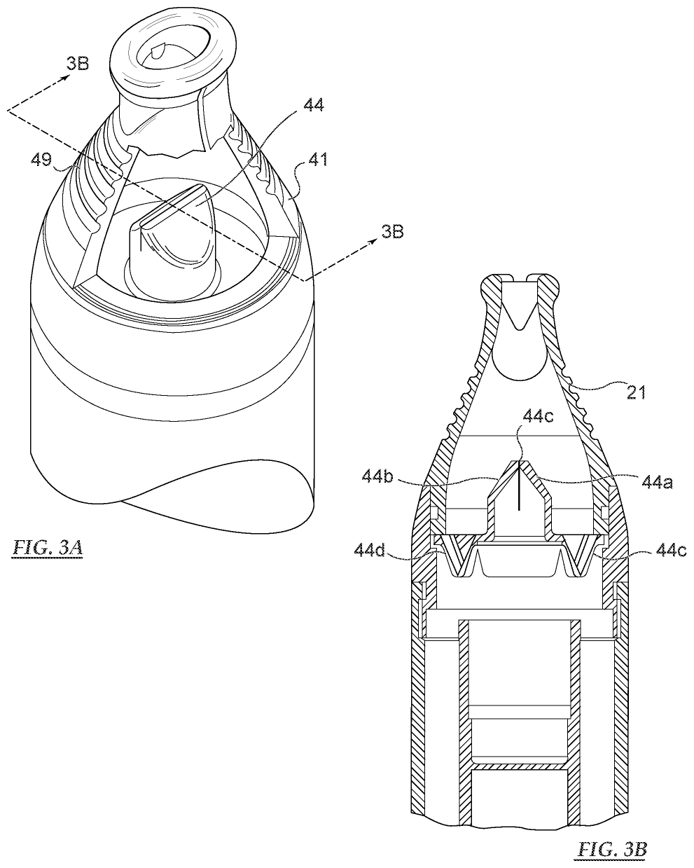

As presented herein the invention is the removable mouthpiece 11, 41 having unique valve technology comprising check valves for the inhale function, the exhale function, individually, or together. Specifically, one or more of the inlet 44 and outlet 45 check valves comprise a right 44a flap or a left 44b that taper to a cylinder (FIG. 3A and FIG. 3B). The cylindrical base could also be a polygonal base as mouthpiece 11 depicted in FIG. 2B has a polygonal base.

FIG. 2A is illustrative of a pen type 97 vaporizer illustrates a stick-type vaporizer being introduced to filter assembly of the present invention. As shown without the mouthpiece that is removable and separate, the sleeve is a dual channel 12, 13 with the filter introduced on one side 12 and the pen 97 introduced on an opposite side 13. Both 97, 98 are held in place by friction fit. The dual mouthpiece 11, 41 of the present invention allows a user to inhale and exhale into the same opening 15 while remaining versatile to a multitude of pen 97 and stick type 96 vaporizers and e-cigarettes. Even though opposite channel 13 is rectilinear, the round 97 pen will fit the channel because the sleeve 22 material has enough elasticity to receive and hold the device 97.

FIG. 2B is an additional exploded view of the present invention shown without the protective jacket 21 but with the removable mouthpiece 11 that couples directly to the sleeve 22. Herein, sleeve 22 couples to the mouthpiece 11 and the filter 10 slides through 12 the sleeve and connects to the mouthpiece. Either a stick 96 or a vape pen 97 can be chosen by a user with an adaptor 94 included, if needed, to accommodate differences in geometry between vaporizer opening and the inlet 31 to the mouthpiece. The adaptor 94 could either convert a round opening to a square, or vice versa, and could be provided in varying sizes.

With regard to FIG. 2C, a profile view of the present invention 10 is illustrated with all removable components 97, 98, 11 assembled together. In this illustration, the protective jacket 21 covering the neck area is not included. For reference purposes, the neck area is on the device 10 where the sectional line 2D-2D is drawn on FIG. 2C.

FIG. 2D illustrates a partial cross-section view focused to the removeable mouthpiece 11 taken along line 2D-2D of FIG. 2C. Its dual action is provided by two check valves 44, 45; one for inlet 44 from the vaporizer and a second 45 for outlet to the filter. A male post 34 internal to the mouthpiece engages the filter 98 opening 95 (shown in FIG. 2A in dashed lines and again in FIG. 2B without dashed lines) so that exhaled vapor is appropriately channeled to the filter 98. While the upper portion of the dual sleeve 11 is rigid for mouthpiece 11 support, internal openings 31, 34 of the mouthpiece are flexible for friction fit to the vaporizer 96, 97 and filter 98, respectively. In a preferred embodiment, flexible grommets 32 are configured to the internal openings 31 providing this function. In the exhale function, check valve 45 is connected to a funnel 33, channeling air toward the valve 45. The mouthpiece 11 further has an inlet plenum that is interior to mouthpiece 15 encompassed by the outlet of the right check valve 44 and inlet of left check valve 45 as shown in FIG. 2B. As stated, the outer jacket 21 housing valve components 31, 32, 33, 34, 44, 45 is also comprised of flexible or soft polymer material.

As detailed herein the invention 10 includes a sleeve 22 comprising: a first lengthwise channel 12, parallel to a longitudinal axis 99 of the sleeve 11, for receiving the exhale filter device 98. Additionally, the accessory sleeve 11 has a second lengthwise channel 13 parallel to the first lengthwise channel 12 for receiving a vaporizer 96, 97, wherein the first and second channels are juxtaposed and configured to friction fit both the vaporizer 96, 97 and the exhale filter device 98. In a preferred embodiment, he upper part (neck portion) of the sleeve 22 is rigid polymer for structural support of the mouthpiece 11 while the lower part of the sleeve (everything underneath the neck portion) is flexible for friction fit of the vaporizer juxtaposed to the filter device with the sleeve.

With regard to FIG. 3A, an alternative removable mouthpiece 41 embodiment is shown in perspective having a portion removed revealing the inlet plenum. Diverter valve 44 is further applicable to the previous mouthpiece 11 embodiment (FIG. 2D). As shown, the mouthpiece 41 has annular ribs 49 for griping and flexing.

With reference to FIG. 3B a cross-sectional view of a mouthpiece portion 41 is shown with flaps 44d and 44e on lateral sides of diverter valve 44 that stay shut in the inhale function and will unseat and open in the exhale function. The duckbill valves 44 introduced herein remain shut to all air flow in the relaxed/steady state. Specially, the valve 44 is constructed so that only a one-way differential pressure will cause the valve 44 to open; and when pressure subsequently equalizes, the valve 44 returns to steady state. In the inhale function, pressure in the inlet plenum will drop below pressure in the other side (center, or right FIG. 2D)) 44c causing the valve 44 to open. In the exhale function, greater pressure in the one side will not cause the valve 44 to open in the center 44c as its design acts like a check valve. Instead, air is diverted around the outside of the valve 44 into the device filter.

More specifically referencing FIG. 3B, the second mouthpiece embodiment 41 is designed with a dual duck valve configuration wherein a first pair of flaps 44a, 44b meet at a center forming a ridge 44c and wherein second 44d and third 44e pairs of flaps are on lateral sides of the first pair of flaps 44a, 44b. As before, the center/first pair of flaps 44a, 44b are open for the inhale function; and, the first pair of flaps 44a, 44b are to remain shut for the exhale function. However, in this embodiment 41, second 44d and third 44e pairs of flaps are shut for the inhale function, wherein the second and third pairs of flaps 44d, 44e remain open for the exhale function. More specifically, the flaps 44a, 44b, 44c, 44d are check valves that open when pressure drops at an exterior thereof (44a, 44b due to inhalation). Or, they 44d, 44e open when pressure at an interior thereof increases and reaches a threshold (due to exhalation). As shown in FIG. 3B, a slit is shown directly underneath ridge 44c between flaps 44a and 44b. It is additionally contemplated that the valve 44 could operate without this additional slit 44c. Also notably, both the diverter valve 44 and mouthpiece 41 have a cylindrical base that forms the bottom of the inlet plenum. The mouthpiece 11, 41 of the present invention is further designed removable from a separate main component 22. As stated, the cylindrical base could be a polygonal base as in valve 11 embodiment shown in FIG. 2A, FIG. 2B and FIG. 2D.

While the particular Accessory E-Cigarette Filter Assembly herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A filter assembly for a vaporizer comprising:
a filter for receiving a user's exhale;
a channel for receiving a vaporizer; and
a dual mouthpiece coupled to an upper portion of the channel, the dual mouthpiece further comprising an inlet check valve and an outlet check valve, the inlet and outlet check valve for and allowing vapor drawn therethrough in an inhale function and subsequently exhaled to the filter in an exhale function.

2. The filter assembly for a vaporizer of claim 1 further comprising said vaporizer providing the vapor drawn therethrough in the inhale function, wherein the channel comprises a dual channel sleeve for receiving a filter on a channel first side, further wherein the vaporizer is configured juxtaposed to the filter on a channel second side.

3. The filter assembly for a vaporizer of claim 1 further comprising a jacket configured at least partially around an outside of the dual mouthpiece, the jacket providing impact resistance thereto.

4. The filter assembly for a vaporizer of claim 1, the dual mouthpiece further comprising:
a funnel connected the outlet check valve; and
an inlet from the vaporizer including a flexible gromet that provides a seal between the vaporizer and the dual mouthpiece.

5. The filter assembly for a vaporizer of claim 2, the inlet check valve comprising a duck bill valve configuration including:
a cylindrical base; and
a pair of flaps meeting at a ridge, the flaps further extending to the cylindrical base on the duck bill valve wherein the dual mouthpiece includes a base that is either cylindrical or rectangular.
